(19) United States
(12) Patent Application Publication
(10) Pub. No.: US 2026/0107888 A1
(43) Pub. Date: Apr. 23, 2026

(54) POTTED PLANT WATERING ASSEMBLY

(71) Applicant: Raj Kagathi, Naperville, IL (US)

(72) Inventor: Raj Kagathi, Naperville, IL (US)

(21) Appl. No.: 18/921,859

(22) Filed: Oct. 21, 2024

(51) Int. Cl. A01G 27/00; A01G 9/02; A01G 27/04

(52) U.S. Cl. CPC A01G 27/008; A01G 27/04

(57) ABSTRACT

A potted plant watering assembly includes a panel having orifices to permit the passage of water, support legs connected to the panel, a watering tube, a water level indicator, and a wick. The watering tube is connected to and passes through the panel. The watering tube is designed to extend upwardly beyond soil on the panel when positioned in a pot. The water level indicator includes a rod movably mounted in the watering tube and a float positioned adjacent the legs. The float is movable by water in a pot below the panel to thereby move the rod to indicate a level of water in a space between the panel and a bottom of the pot. The wick is insertable through one of the orifices and designed to conduct water from below the panel to soil above the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to accessories for potted plants and more particularly pertains to a new potted plant watering assembly for passively watering plants in a pot from below, wherein a panel supports the soil and the plant from below, but the panel is positioned on legs a distance from the bottom of the pot to form a water reservoir and wicks passing through the panel transport the water from the reservoir to the soil.

### (2) Description of Related Art Including Information Disclosed under 37 CFR 1.97 and 1.98

The prior art relates to accessories for potted plants. The prior art, as best understood, does not disclose a potted plant watering assembly, designed to be inserted into a pot to support a layer of soil a distance from a bottom of a pot, that includes a panel having orifices to permit the passage of water, support legs connected to the panel, a watering tube, a water level indicator, and a wick insertable through one of the orifices and designed to conduct water from below the panel to soil above the panel.

### BRIEF SUMMARY OF THE INVENTION

An embodiment of the disclosure meets the needs presented above in a potted plant watering assembly generally comprising a panel having orifices to permit the passage of water, support legs connected to the panel, a watering tube, a water level indicator, and a wick. The watering tube is connected to and passes through the panel. The watering tube is designed to extend upwardly beyond soil on the panel when positioned in a pot. The water level indicator includes a rod movably mounted in the watering tube and a float positioned adjacent the legs. The float is movable by water in a pot below the panel to thereby move the rod to indicate a level of water in a space between the panel and a bottom of the pot. The wick is insertable through one of the orifices and designed to conduct water from below the panel to soil above the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a potted plant watering assembly according to an embodiment of the disclosure.

FIG. 2 is a perspective view of an embodiment of the disclosure.

FIG. 3 is a top view of an embodiment of the disclosure.

FIG. 4 is a cross-sectional view of an embodiment of the disclosure.

FIG. 5 is a perspective view of an embodiment of the disclosure in use.

FIG. 6 is a cross-sectional view of an embodiment of the disclosure in use.

FIG. 7 is a cross-sectional view of an embodiment of the disclosure in use.

### DETAILED DESCRIPTION OF THE INVENTION

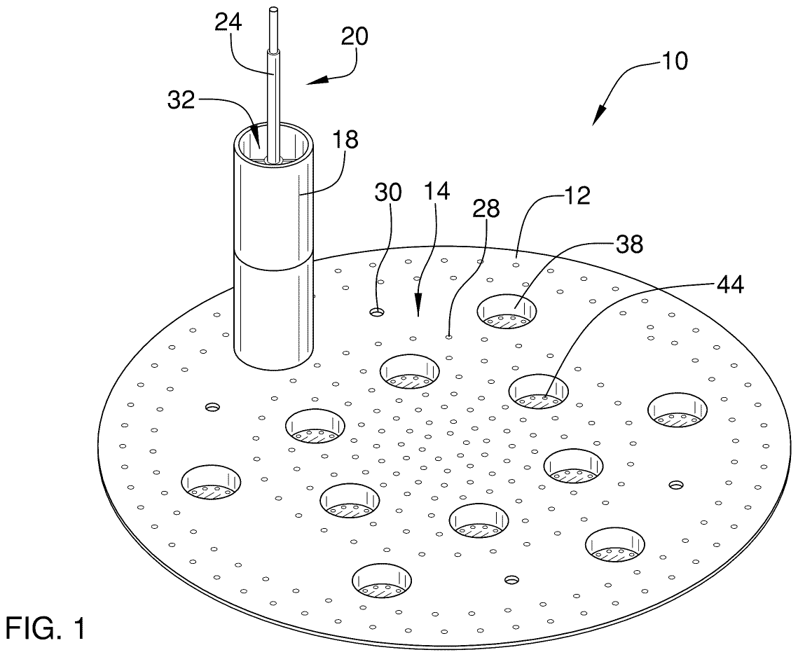

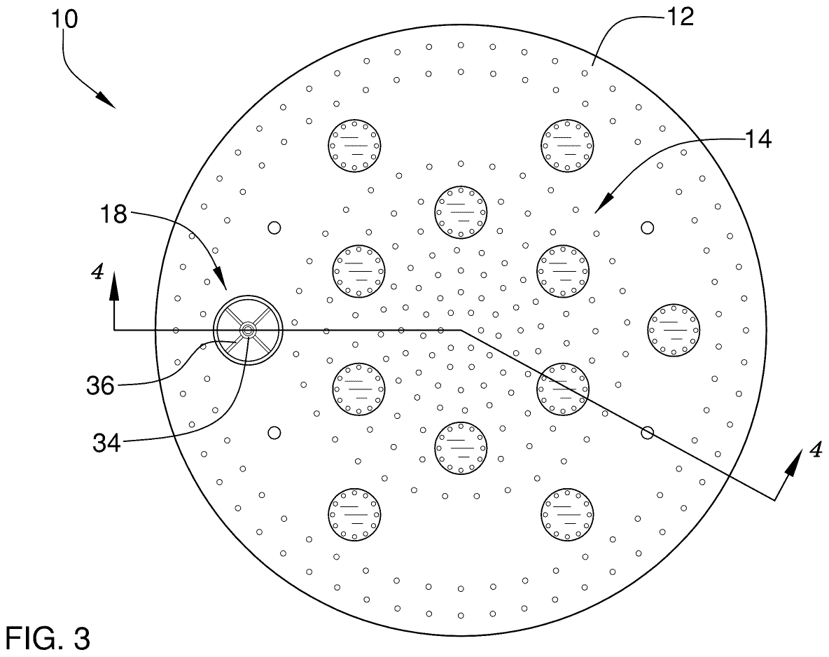

With reference now to the drawings, and in particular to FIGS. 1 through 7 thereof, a new potted plant watering assembly embodying the principles and concepts of an embodiment of the disclosure and generally designated by the reference numeral 10 will be described.

As best illustrated in FIGS. 1 through 7, the potted plant watering assembly 10 is designed to be inserted into a pot 60 to support a layer of soil 62 a distance from a bottom 64 of a pot 60. The potted plant watering assembly 10 generally includes a panel 12 having orifices 14 to permit the passage of water 66, support legs 16 connected to the panel 12, a watering tube 18, a water level indicator 20, and a wick 22. The watering tube 18 is connected to and passes through the panel 12. The watering tube 18 is designed to extend upwardly beyond the soil 62 on the panel 12 when positioned in the pot 60. The water level indicator 20 includes a rod 24 movably mounted in the watering tube 18 and a float 26 positioned adjacent the legs. The float 26 is movable by water 66 in the pot 60 below the panel 12 to thereby move the rod 24 to indicate a level of water 66 in a space 68 between the panel 12 and a bottom 64 of the pot 60. The wick 22 is insertable through one of the orifices 14 and designed to conduct water 66 from below the panel 12 to soil 62 above the panel 12.

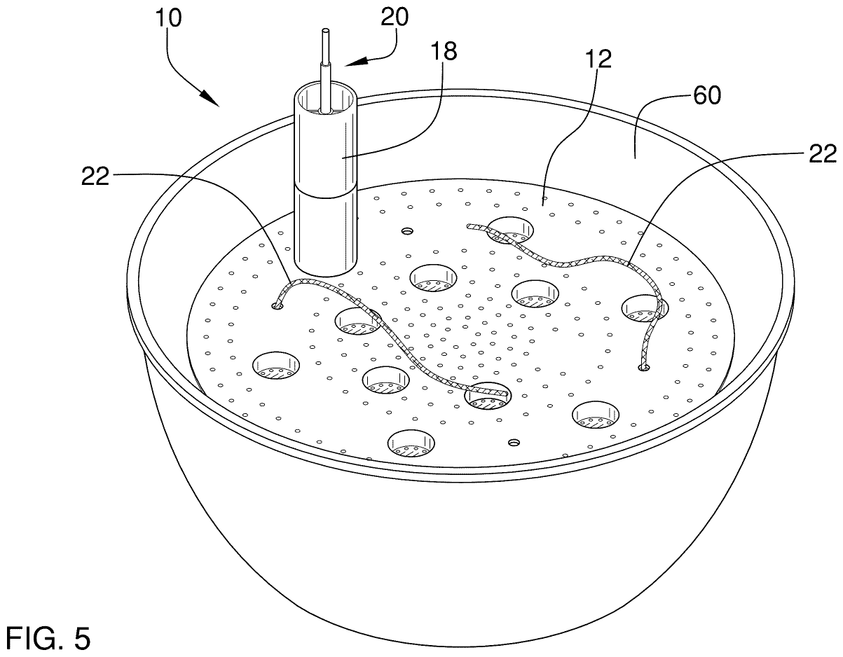

In the exemplary embodiment shown, the orifices 14 comprise a first plurality of smaller orifices 28 and a second plurality of larger orifices 30. However, it should be understood that the orifices 14 could be all the same size or a variety of different sizes. In the exemplary embodiment shown, the wick 22 is selectively insertable only through one or more of the second plurality of larger orifices 30. However, the wick 22 and the orifices 14 could be sized as desired, such that the wick 22 can fit through any of the orifices 14. As shown in FIG. 5, the potted plant watering assembly 10 can include a plurality of the wicks 22.

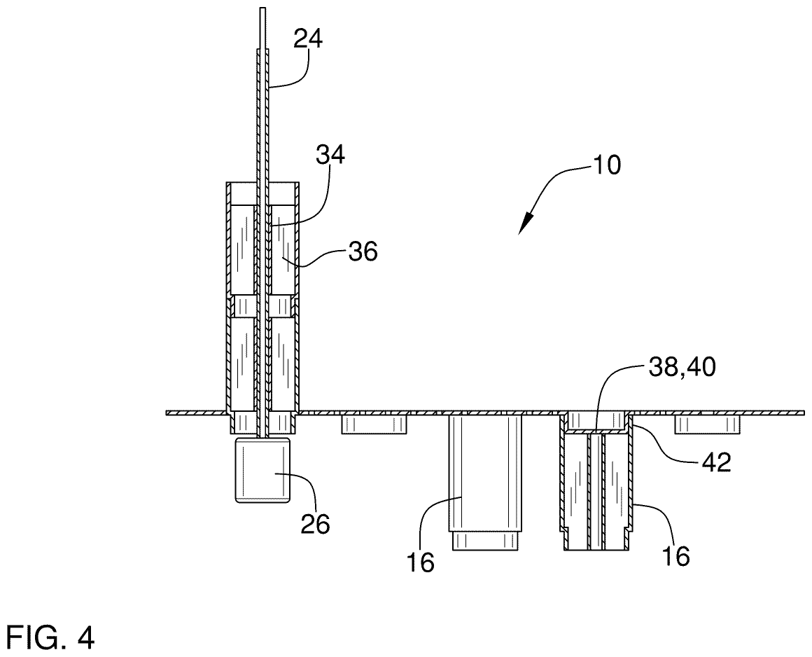

The water level indicator 20 includes a guide structure 32 attached to an interior surface of the watering tube 18 and designed to hold the rod 24. In the exemplary embodiment shown in FIG. 4, the guide structure 32 includes a guide tube 34 supported by arms 36, though this is only one example and other designs of the guide structure 32 are within the scope of the disclosure. The rod 24 is longer than the watering tube 18 and projects out of opposite ends of the watering tube 18.

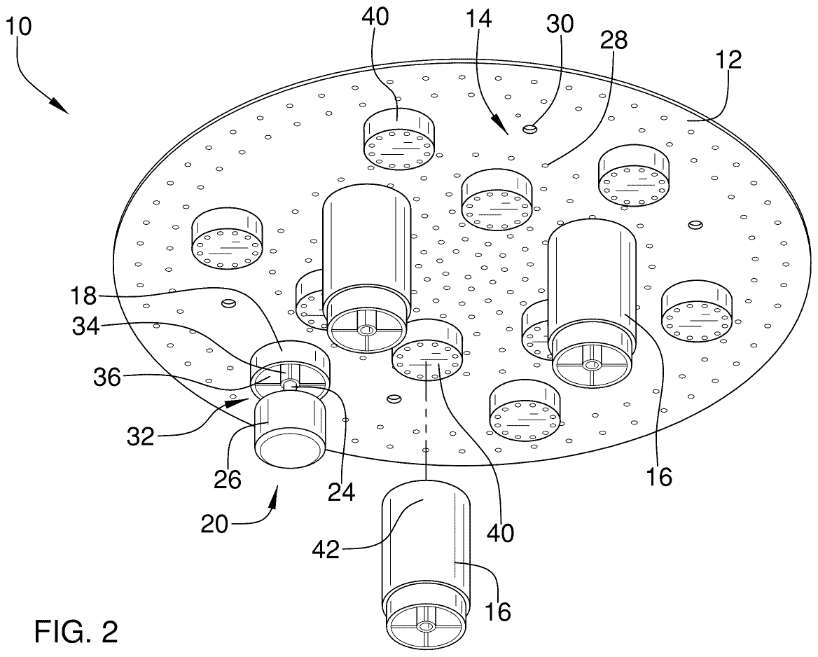

In the exemplary embodiment shown in FIGS. 1 and 2, the panel 12 includes a plurality of indentations 38 that form projections 40 on an underside thereof. Each of the support legs 16 is selectively and removably connectable to any one of the projections 40 as shown in FIG. 2. In the exemplary embodiment, each of the support legs 16 includes a sleeve portion 42 that fits over the projections 40 to connect the support legs 16 by friction fit. This design allows a user to selectively connect any number of support legs 16 in a desired configuration. The support legs 16 could be connected to the panel 12 in different ways, either removably or permanently, or could be formed integrally with the panel 12. The indentations 38 could also be omitted and the projections 40 could be solid. The panel 12 is shown as being round, though other shapes such as rectangular or oval are within the scope of the disclosure. The panel 12 could also be different sizes for pots 60 of different sizes. The support legs 16 could be about three inches in length, though other sizes are possible. In one possible embodiment, the watering tube 18 could be formed from one or more of the support legs 16 for convenience of manufacture.

With reference to FIG. 2, in the exemplary embodiment, each of the projections 40 has perforations 44 or similar openings, which would allow for the bottom 46 of the corresponding projection 40 to be pushed or cut out to form a passage through the projection 40, as well as possibly allow passage of liquid depending on the size. This design option can allow for relocation of the water level indicator 20 by removal and insertion into the projection 40. Such optional relocation of the water level indicator 20 could be useful when resizing the panel 12, which could be done by cutting off a ring-shaped outer section to make the diameter of the panel 12 smaller. For example, if a user were to cut along the outermost ring of orifices 28 shown in FIG. 1, the portion of the panel 12 that supports the water level indicator 20 would be removed, necessitating the relocation of the water level indicator 20 to one of the remaining indentations 38 or projections 40. In addition, in one possible embodiment, all or some of the orifices 28 could be arranged in concentric rings to be used as a guide for manually cutting the panel 12 to resize the panel 12 yet maintain the circular shape. Alternatively, printed guidelines, possibly with measurements, or perforations could be utilized to assist a user in cutting the panel 12 to different sizes. It should be understood that the positioning of the smaller orifices 28, larger orifices 30, and the indentations 38 as shown in the drawings are exemplary embodiments, and that the orifices 28 and the indentations 38 could be positioned in any arrangement as desired at the time of manufacture.

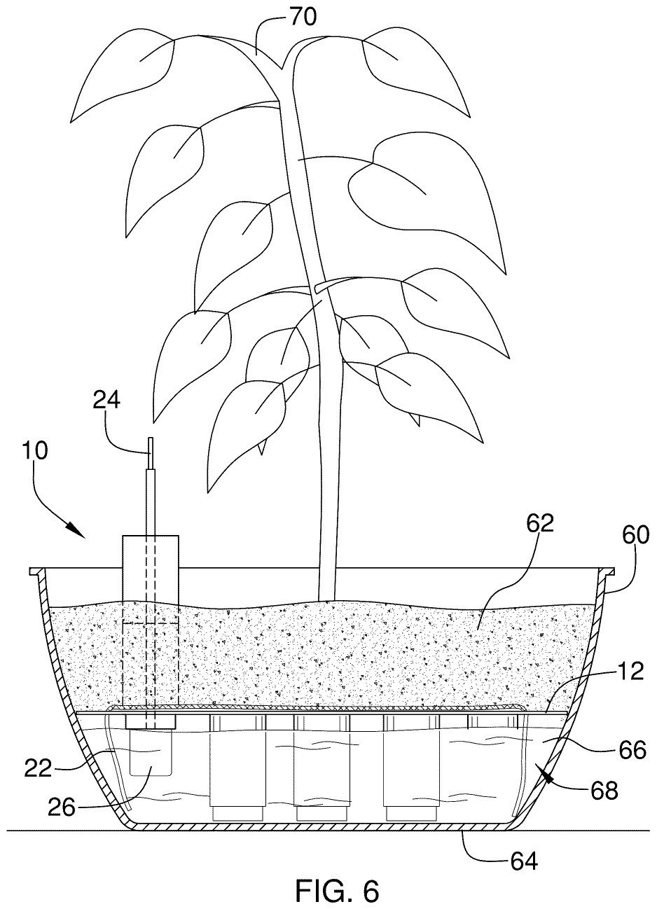

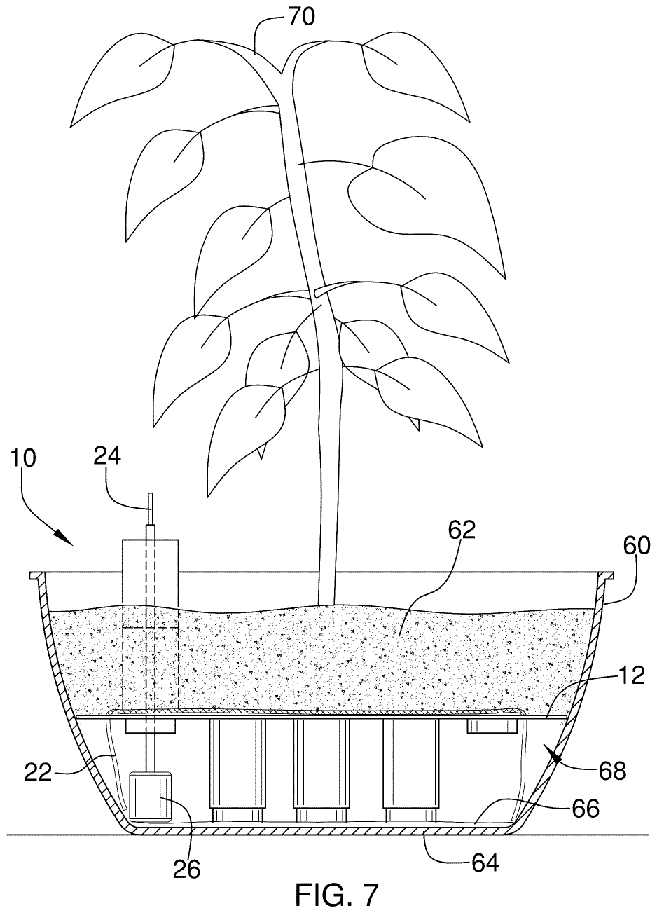

In use, a user inserts the potted plant watering assembly 10 in the pot 60, with the support legs 16 seated on the bottom 64 of the pot 60. Soil 62 is placed on the panel 12 and around the watering tube 18. Water 66 is poured through the watering tube 18 and into the space 68 between the panel 12 and the bottom 64. The float 26 rises with the water 66 until the float 26 hits the bottom of the guide tube 34, as shown in FIG. 6. The rod 24 is maximally extended from the guide tube 34, indicating to the user that the space 68 is full of water 66. The wicks 22 passively conduct water 66 into the soil 62 to water a plant 70. Water 66 can also evaporate and pass through the orifices 14 into the soil 62. As the water 66 is used up, the level decreases and the float 26 is lowered, as shown in FIG. 7. The rod 24 is also lowered to indicate to the user that water 66 needs to be added.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A potted plant watering assembly to be inserted into a pot to support a layer of soil a distance from a bottom of a pot, comprising:
a panel comprising orifices to permit the passage of water;
support legs connected to said panel;
a watering tube connected to and passing through said panel, wherein said watering tube is configured to extend upwardly beyond soil on said panel when positioned in a pot;
a water level indicator comprising a rod movably mounted in said watering tube and a float being disposed fully outside of said watering tube under said panel adjacent said legs and movable by water in a pot below said panel to thereby move said rod to indicate a level of water in a space between said panel and a bottom of a pot; and
a wick insertable through one of said orifices and configured to conduct water from below said panel to soil above said panel.

2. The potted plant watering assembly of claim 1, wherein said orifices comprise a first plurality of smaller orifices and a second plurality of larger orifices.

3. The potted plant watering assembly of claim 2, wherein said wick is selectively insertable only through one or more of said second plurality of larger orifices.

4. The potted plant watering assembly of claim 1, wherein the potted plant watering assembly comprises a plurality of said wicks.

5. The potted plant watering assembly of claim 1, wherein said water level indicator comprises a guide structure attached to an interior surface of said watering tube and configured to hold said rod.

6. The potted plant watering assembly of claim 5, wherein said rod is longer than said watering tube and projects out of opposite ends of said watering tube.

7. The potted plant watering assembly of claim 1, wherein said panel comprises a plurality of indentations that form projections on an underside thereof.

8. The potted plant watering assembly of claim 7, wherein each of said support legs is selectively and removably connectable to any one of said projections.

9. The potted plant watering assembly of claim 8, wherein each of said support legs comprises a sleeve portion that fits over said projections to connect said support legs by friction fit.

10. A potted plant watering assembly to be inserted into a pot to support a layer of soil a distance from a bottom of a pot, comprising:
a panel comprising orifices to permit the passage of water, wherein:
said orifices comprise a first plurality of smaller orifices and a second plurality of larger orifices,
said panel comprises a plurality of indentations that form projections on an underside thereof;
support legs connected to said panel, wherein:
and each of said support legs is selectively and removably connectable to any one of said projections,
each of said support legs comprises a sleeve portion that fits over said projections to connect said support legs by friction fit;
a watering tube connected to and passing through said panel, wherein said watering tube is configured to extend upwardly beyond soil on said panel when positioned in a pot;
a water level indicator comprising a rod movably mounted in said watering tube and a float being disposed fully outside of said watering tube under said panel adjacent said legs and movable by water in a pot below said panel to thereby move said rod to indicate a level of water in a space between said panel and a bottom of a pot, wherein:
said water level indicator comprises a guide structure attached to an interior surface of said watering tube and configured to hold said rod,
said rod is longer than said watering tube and projects out of opposite ends of said watering tube; and
a wick insertable through one of said orifices and configured to conduct water from below said panel to soil above said panel, wherein:
said wick is selectively insertable only through one or more of said second plurality of larger orifices,
the potted plant watering assembly comprises a plurality of said wicks.
